(19) United States
(12) Patent Application Publication
(10) Pub. No.: US 2004/0174342 A1
(43) Pub. Date: Sep. 9, 2004

(54) Signal reproducing apparatus

(75) Inventors: Tokuo Yokota, Osaka (JP); Hitoshi Ogata, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: SANYO ELECTRIC CO., LTD., Moriguchi-shi (JP); SANYO TECHNOSOUND CO., LTD., Daito-shi (JP)

(21) Appl. No.: 10/790,206

(22) Filed: Mar. 2, 2004

(30) Foreign Application Priority Data
Mar. 6, 2003 (JP) 2003-059282

(51) Int. Cl. G09G 5/00

(52) U.S. Cl. 345/172

(57) ABSTRACT

The present invention provides a signal reproducing apparatus having one special function button arranged on the apparatus body. An incorporated memory of a microcomputer 3 has stored therein a plurality of pieces of function information indicating a function to be performed when the special function button 6 is manipulated. With a recording medium placed therein, the microcomputer 3 specifies function information in conformity with function specifying information included in management information recorded on the recording medium from among a plurality of pieces of function information stored in the incorporated memory, and executes an operation in conformity with the specified function information when the special function button 6 is manipulated in this state. This can realize the signal reproducing apparatus for performing the manipulation with ease when a desired function is to be performed.

### FIELD OF THE INVENTION

The present invention relates to a signal reproducing apparatus for placing a recording medium such as a DVD and CD therein.

### BACKGROUND OF THE INVENTION

DVD players have various functions which can be performed by the manipulation of a plurality of manipulation buttons arranged on the player. Alternatively the functions can be performed by selecting the manipulation button presented on a menu which is shown on the display arranged on the player.

Some of the contents of software recorded on a disk may allow the DVD player to have a special reproducing function. For example, the present applicants have proposed a disk apparatus which is capable of specially reproducing a CD on which educational program is recorded. (JP-A-8-180649)

The DVD player having such a special function can have arranged on the player a specific manipulation button for each special function, or can have shown on the display another specific manipulation button for each special function.

However, in the case where the DVD player can have arranged on the player a specific manipulation button for each special function, or in the case where the player can have shown on the display another specific manipulation button for each special function, there arises the problem of selecting a manipulation button assigned a desired function from among a number of manipulation buttons when the desired function is to be performed.

### SUMMARY OF THE INVENTION

An object of the present invention is to provide a signal reproducing apparatus which can be manipulated with ease for performing a desired function.

Known as a standard for DVD is a standard for recording, along with video data and audio data, management information entitled navigation data on DVD. The standard makes it possible to use 16 parameters entitled general parameters, and also possible to record, on DVD, navigation commands for setting, computing, and comparing the general parameters serving as navigation data.

The present inventors have intensively conducted studies for solving the aforementioned problem to conceive the idea of switching functions of one or more manipulation buttons with use of the general parameters to thereby accomplish the present invention.

The present invention provides a signal reproducing apparatus for placing a recording medium therein and reproducing a signal and management information of the signal which are recorded on the medium. The signal reproducing apparatus comprises:

one or more manipulation buttons,

storing means for storing a plurality of pieces of function information indicating a function to be performed when the one or more manipulation buttons are manipulated,

function specifying means for, with a recording medium placed therein, specifying function information in conformity with function-specifying information included in management information recorded on the recording medium from among a plurality of pieces of function information stored in the storing means with respect to each manipulation button, and

means for activating an operation in conformity with the specified function information with respect to one of the one or more manipulation buttons when said manipulation button is manipulated with the recording medium placed therein.

The signal reproducing apparatus of the present invention has stored in the function information storing means a plurality of pieces of function information indicating a function to be performed when the one or more manipulation buttons are manipulated. With a recording medium placed therein, function information in conformity with the function-specifying information included in the management information recorded on the recording medium from among the plurality of pieces of function information with respect to each manipulation button is specified. When one of the one or more manipulation buttons is manipulated, an operation in conformity with the function information which is specified with respect to said manipulation button is activated.

The functions of the one or more manipulation buttons are thus switched in conformity with the function specifying information recorded on the recording medium, so that no manipulation buttons for respective functions need be arranged on the apparatus body. This reduces the number of manipulation buttons to be arranged on the apparatus body, and enables the user to manipulate the manipulation button with ease for performing a desired function. Furthermore placing the recording medium into the apparatus body automatically switches the functions of the manipulation button, whereby no manipulation is required for switching the functions of the manipulation button.

Stated specifically, the function specifying information comprises a plurality of parameters. The function specifying means specifies function information based on the plurality of parameters.

There are a number of combinations of the plurality of parameters. According to the specific construction described, the combinations of the parameters are used for specifying function information, so that even if a number of pieces of function information are stored in the storing means, one piece of function information can be specified. With a number of pieces of function information stored in the storing means, the functions of one or more manipulation buttons can be switched among a number of functions.

Stated specifically, the management information includes an operational parameter and program for activating a predetermined operation based on a value of the operational parameter, the signal reproducing apparatus comprising:

parameter storing means for storing the operational parameter,

storage processing means for storing, in the storing means, the operational parameter included in the management information recorded on the recording medium with the recording medium placed therein. The means for activating operation activates an operation for rewriting the operational parameter stored in the storing means when one manipulation button is manipulated. The program activates a predetermined operation in accordance with a value of the operational parameter stored in the storing means.

According to the specific construction, the operational parameter and the program for activating a predetermined operation in accordance with a value of the operational parameter are recorded as the management information on the recording medium. With the recording medium placed therein, the storage processing means stores, in the parameter storing means, the operational parameter included in the management information recorded on the recording medium. Thereafter, whenever one manipulation button is manipulated, the means for activating operation rewrites the operational parameter stored in the parameter storing means. Then the program recorded on the recording medium activates a predetermined operation in accordance with a value of the operational parameter stored in the parameter storing means. Stated specifically, when a desired function is to be executed, the program for activating an operation in conformity with the function is recorded on the recording medium, and there is no need to change program provided on the signal reproducing apparatus.

Stated further specifically the reproducing apparatus comprises an information display and display controlling means for showing on the information display a function indicated by function information when the function information is specified by the function specifying means. According to the specific construction, functions of the one or more manipulation buttons are shown on the information display, so that the user can become aware of the functions of the one or more manipulation buttons before the user manipulates the manipulation buttons.

As described above, the signal reproducing apparatus of the present invention can realize the easy manipulation for performing a desired function.

### BRIEF DESCRIPTION OF THE DRAWINGS

FIG. 1 is a block diagram showing the construction of a DVD player embodying the invention;

FIG. 2 is a diagram showing the data structure of bit stream recorded on a DVD;

FIG. 3 is a diagram showing the data structure of Video Object Set for Titles included in the aforementioned bit stream;

FIG. 4 is an illustration showing an example of a function assigning table;

FIG. 5 is a flowchart showing a procedure example to be executed by a general parameter setting command;

FIG. 6 is a flowchart showing a procedure to be executed by function assigning program;

FIG. 7 is a flowchart showing another procedure example to be executed by the general parameter setting command;

FIG. 8 is a flowchart showing a procedure to be executed by general parameter rewriting program;

FIG. 9 is a flowchart showing a procedure to be executed by an operation activating command.

### DETAILED DESCRIPTION OF EMBODIMENT

With reference to the drawings, a detailed description will be given of the present invention as embodied into a DVD player for an educational purpose.

The standard for DVD will be described firstly, and then the construction and operation of the DVD player of the present invention will be explained. A DVD has one or more titles recorded thereon, and one title comprises a plurality of chapters.

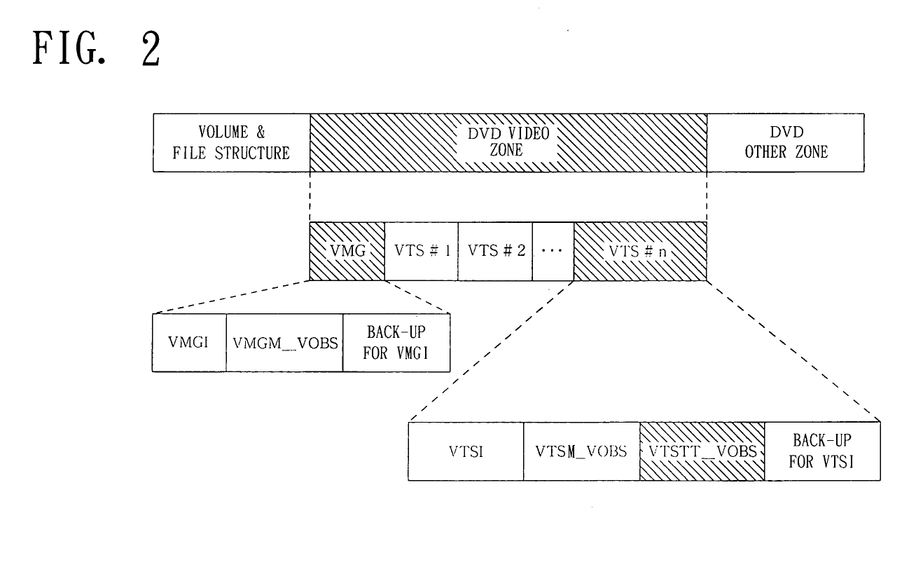

DVDs contain zone for recording volume and file structure, DVD-Video zone, and DVD-other zone, as seen in FIG. 2. The zone for recording volume and file structure has recorded thereon data for defining the file structure of disks and data entitled descriptor. A volume set identifier included in the descriptor is used for the identification of disks.

DVD-Video zone has recorded thereon one Video Manager (VMG) and one or more Video Title Sets (VTS).

The VMG comprises Video Manager Information (VMGI), Video Object Set for VMG Menu (VMGM_VOBS), and the backup data for VMGI. The VMGI is made up of management information for the entire DVD-Video zone, e.g., an initial address of one or more VTS recorded on the DVD-Video zone. The VMGM_VOBS contains image data and audio data of title menu.

On the other hand, each VTS comprises Video Title Set Information (VTSI), Video Object Set for VTS Menu (VTSM_VOBS), Video Object Set for Titles (VTSTT_VOBS), and the backup data for the VTSI.

The VTSM_VOBS contains image data and audio data of one or more sub-menus. Furthermore, the VTSTT_VOBS contains main video data and main audio data constituting one title, e.g., actual video and audio data constituting one film. The VTSI comprises management information for the one title, e.g., a period of time required for reproducing the title, a period of time required for reproducing a cell which will be described below and constituting the VTS, an initial address of the cell, and the cell number of an initial cell constituting each chapter, etc.

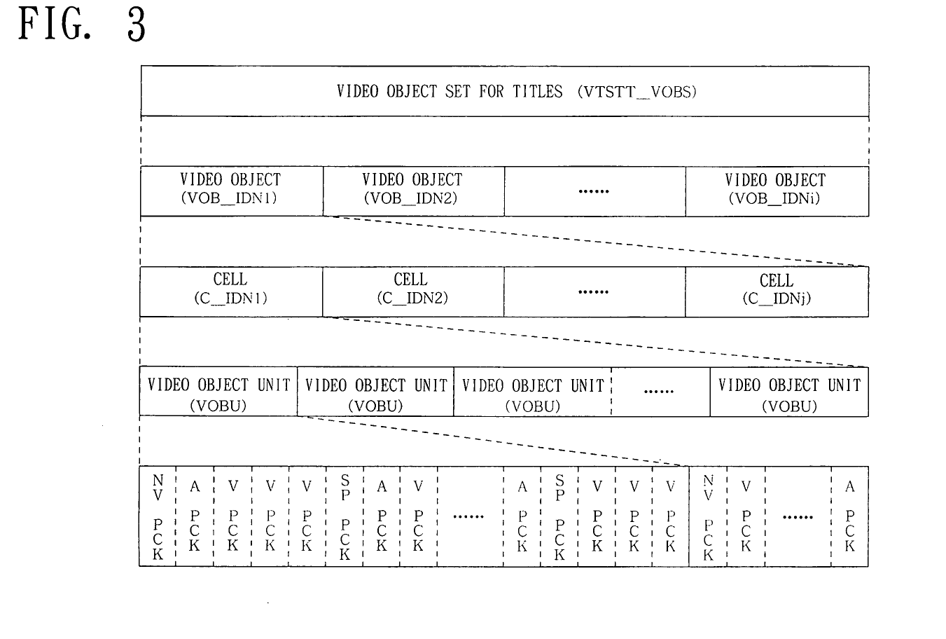

The VTSTT_VOBS is made up of one or more Video Objects (VOB), as shown in FIG. 3, and each VOB contains one or more cells (C).

Each cell (C) is made up of one or more Video Object Units (VOBU), and each VOBU comprises a plurality of pieces of sub-picture data (SP_PCK) including one Navigation Pack (NV_PCK), a plurality of pieces of Video data (V_PCK), a plurality of pieces of Audio data (A_PCK), and subtitle data, etc., which will be described below. Incidentally a plurality of pieces of video data included in one VOBU constitute 1GOP (Group of Pictures).

The Navigation Pack or NV_PCK is made up of management information of VOBU, e.g., a period of time required for reproducing between an initial of the cell to which VOBU belongs and an initial of the VOBU, and initial addresses of VOBUs which are positioned ahead of and next to the VOBU, etc. The Navigation Pack, the VMGI and VTSI shown in FIG. 2 are generically named navigation data.

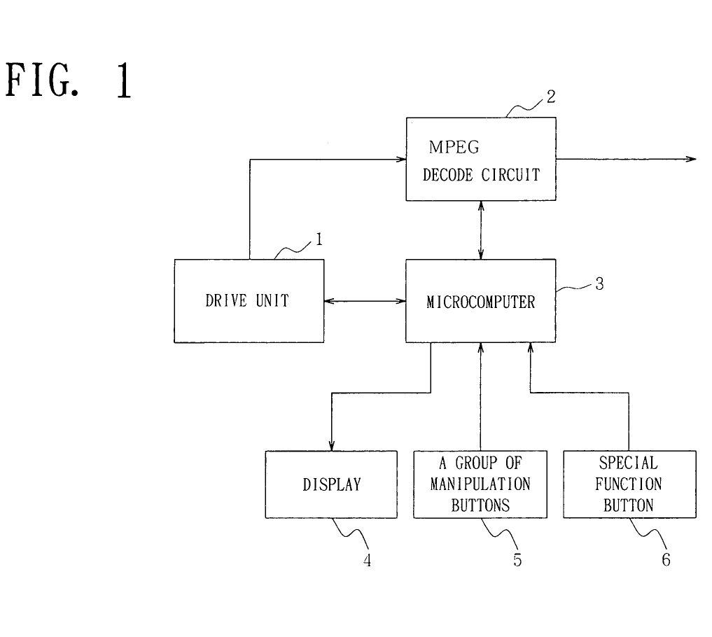

The DVD player of the present invention comprises, as seen in FIG. 1, a drive unit 1 for driving a DVD and reproducing information recorded on the DVD, an MPEG decode circuit 2 for separating video data and audio data, and navigation data from bit stream obtained from the drive unit 1 and decoding the video data and the audio data and outputting the result, and a microcomputer 3 for controlling operation of the drive unit 1 and the MPEG decode circuit 2 based on the navigation data. The microcomputer 3 has connected thereto a display 4 for displaying various information and a group 5 of one or more manipulation buttons.

Furthermore the microcomputer 3 has connected thereto one special function button 6 for switching functions among ten functions 1 to 10 which will be described below.

The DVD standard as described makes it possible to use 16 parameters GPRM 1 to 16 entitled general parameters and having 16-bit length. The VTSI shown in FIG. 2 can include a navigation command for setting, computing and comparing these general parameters.

With the DVD player embodying the present invention, two general parameters GPRM 14, 15 out of 16 general parameters are used for switching the functions of the special function button 6.

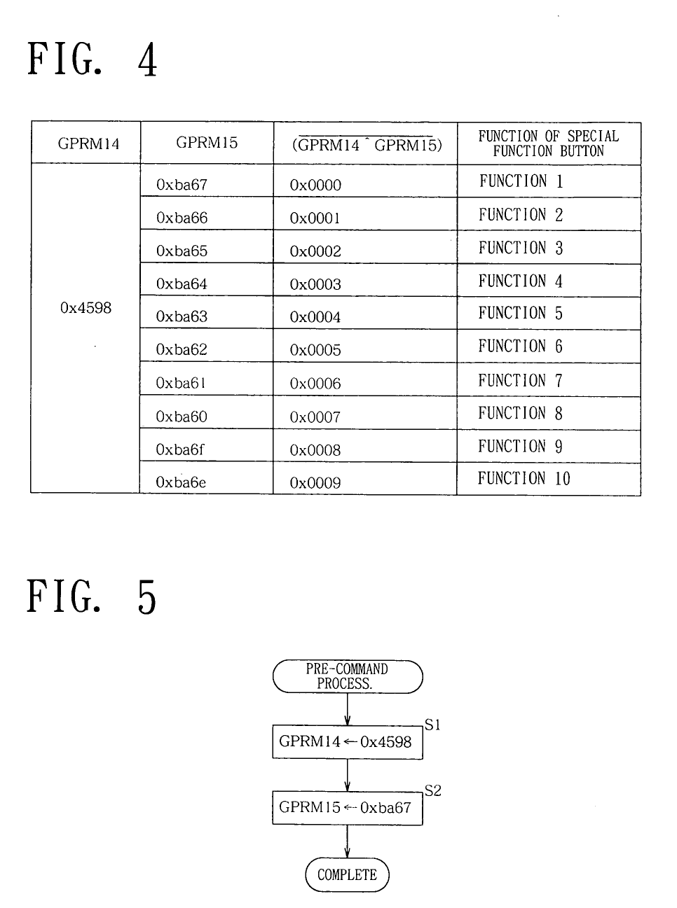

An incorporated memory (not shown) of the microcomputer 3 has stored therein function assigning program to be described below, and has stored therein a function assigning table shown in FIG. 4. Functions 1 to 10 shown in the figure are assigned to functions to be described below, respectively. The functions 1 to 10 are not only assigned to the functions to be described below, but also can be assigned to various other functions.

Functions 1

a function to switch between voice output and subtitle display;

Functions 2

a function to turn on/off a repeat reproducing operation for repeatedly reproducing once a chapter being reproduced;

Functions 3

a function to turn on/off a random reproducing operation for randomly reproducing a plurality of chapters constituting one title;

Functions 4

a function to switch the angle of a reproduced image;

Functions 5

a function to turn on/off a zoom display operation for displaying an enlarged image;

Functions 6

a function to reproduce the Nth chapter of the Mth title;

Functions 7

a function to turn on/off a repeat reproducing operation for repeatedly reproducing a chapter being reproduced a plurality of times;

Functions 8

a function to switch a reproducing mode of voice between usual reproducing mode and low-speed reproducing mode;

Functions 9

a function to perform a marker operation for recording on an incorporated memory or a DVD an address of reproducing position as the location of the start;

Functions 10

a function to turn on/off a repeat reproducing operation for repeatedly reproducing a chapter being reproduced for several seconds.

For example, the VTSI for a title wherein the aforementioned function 1 is assigned to the special function button 6 includes a command for setting the general parameter GPRM 14, 15 as the navigation command.

FIG. 5 shows a procedure to be performed by the command for setting the general parameter before the reproduction of the title. In step S1 a value of the general parameter GPRM 14 is set at “0x4598” to store in the incorporated memory of the microcomputer 3. Then in step S2, as shown in FIG. 4, a value of the general parameter GPRM 15 is set at the predetermined value “0xba67” which is assigned to the function 1 to store in the incorporated memory and complete the procedure.

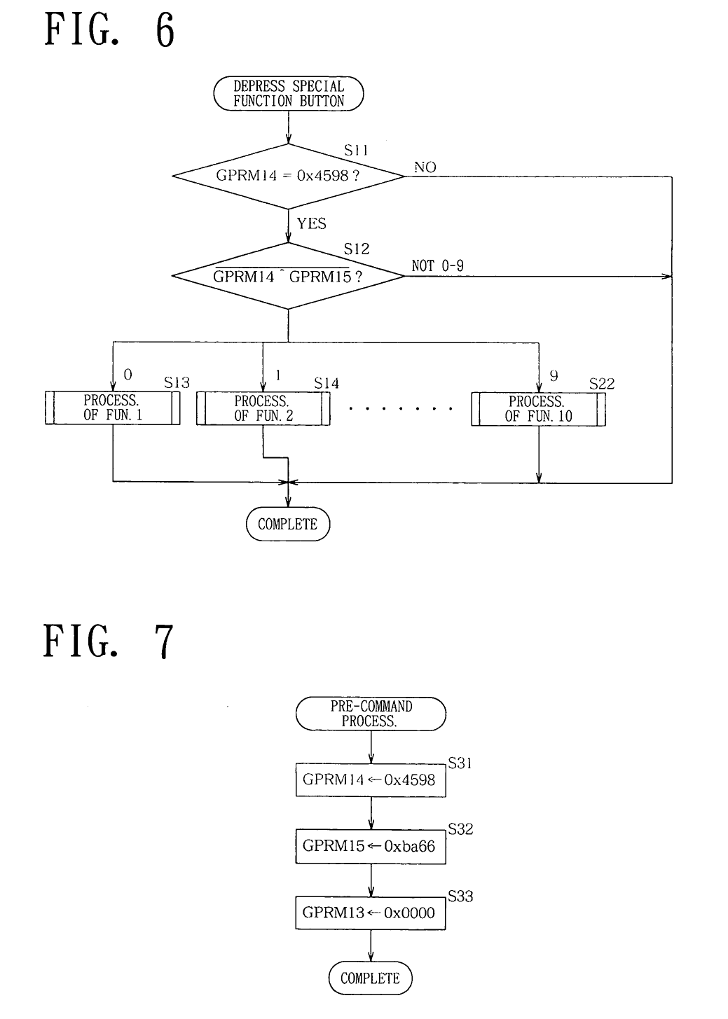

FIG. 6 shows a procedure to be performed by function assigning program stored in the incorporated memory of the microcomputer 3. When the user depresses the special function button 6, an inquiry is made as to whether a value of the general parameter GPRM 14 stored in the incorporated memory is “0x4598” in step S11. If the inquiry is answered in the negative, the procedure is completed. If the answer for step S11 is affirmative, the sequence proceeds to step S12 to inquire whether EXCLUSIVE-OR of the value of the general parameter GPRM 14 and the value of GPRM 15 which are stored in the incorporated memory is one of integers between 0 and 9. When the answer is negative, the procedure is completed.

When EXCLUSIVE-OR of the value of the general parameter GPRM 14 and the value of GPRM 15 is an integer between 0 and 9, processing for executing the functions 1 to 10 is performed in step S13 to S22, respectively to complete the procedure. The procedure switches the functions of the special function button 6 for each title in accordance with the values of the general parameter GPRM 14, 15.

With the DVD player embodying the present invention, a general parameter GPRM 13 of the aforementioned 16 general parameters is used for performing the function of the special function button 6.

For example, the VTSI for the title wherein the aforementioned function 2 is assigned to the special function button 6 includes, as navigation commands, the commands for setting the general parameter GPRM 14, 15 at the predetermined values, respectively, and for initializing the value of the general parameter GPRM 13, and the commands for performing a predetermined operation in conformity with the value of the general parameter GPRM 13, as described above.

The incorporated memory of the microcomputer 3 has stored therein program for rewriting the value of the general parameter GPRM 13.

To be described below is a procedure to be performed before the reproduction of or during the reproduction of the title wherein the function 2 is assigned to the function of the special function button 6.

FIG. 7 shows a procedure to be performed by the command for setting the general parameter before the reproduction of the title. In step S31 a value of the general parameter GPRM 14 is set at the predetermined value, “0x4598” to store in the incorporated memory. Then in step S32, as shown in FIG. 4, a value of the general parameter GPRM 15 is set at the predetermined value “0xba66” which is assigned to the function 2 to store in the incorporated memory. Finally in step S33, a value of the general parameter GPRM 13 is set at the initial value “0x0000” to store in the incorporated memory, completing the procedure.

FIG. 8 shows a procedure to be performed by program for rewriting the general parameter in step S14 shown in FIG. 6. An inquiry is made as to whether a value of the general parameter GPRM 13 stored in the incorporated memory is “00x0000” in step S41. If the inquiry is answered in the negative, the value of the general parameter GPRM 13 is rewritten to “0x0000” in step S42 to complete the procedure. If the answer for step S41 is affirmative, the sequence proceeds to step S43 to rewrite the value of the general parameter GPRM 13 to “0xffff” to complete the procedure. The procedure thus rewrites a value of the general parameter GPRM 13 whenever the user depresses the special function button 6.

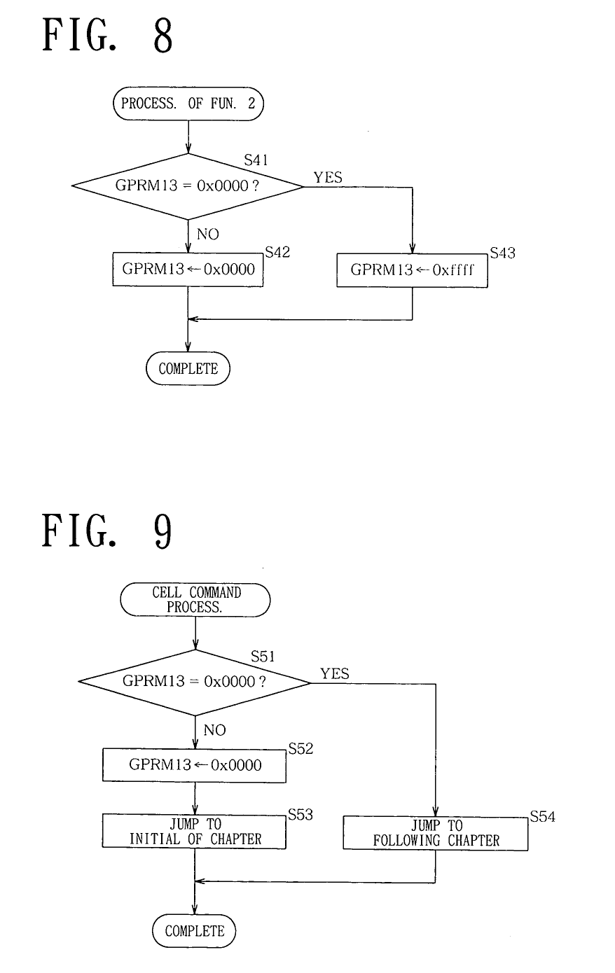

FIG. 9 shows a procedure to be performed by the command for performing an operation when each chapter constituting the title is completely reproduced. An inquiry is made as to whether a value of the general parameter GPRM 13 stored in the incorporated memory is “1x0000” in step S51. If the inquiry is answered in the negative, the sequence proceeds to step S52 to rewrite the value of the general parameter GPRM 13 to “0x0000,” followed by step S53 to jump to the start of the chapter being reproduced to complete the procedure.

On the other hand, if the answer for step S51 is affirmative, the sequence proceeds to step S54 to jump to the start of a chapter which follows the chapter being reproduced and to complete the procedure.

According to the procedure described, when the value of the general parameter GPRM 13 is “0x0000” at the time of completion of the chapter being reproduced, reproduction of a chapter which follows the chapter is started. On the other hand, when the value of the general parameter GPRM 13 is “0xffff” at that time, reproduction of the chapter which has been completely reproduced is started.

The DVD player of the present invention has arranged thereon one special function button 6 for performing the aforementioned ten functions. As described above, the functions of the special button 6 are switched to a function in conformity with the title before reproduction of the title. Accordingly, when a desired function in conformity with the title being reproduced is to be performed, the user will depress the special function button 6, whereby the user can perform the manipulation with ease.

Furthermore the functions of the special function button 6 are automatically switched before the reproduction of the title, so that no manipulation is required for switching the functions.

Further, for performing a desired function, a command for performing an operation in accordance with the desired function based on the value of the general parameter GPRM 13 is recorded on DVD as the navigation command, whereby there is no need to change the program stored in the incorporated memory of the microcomputer 3.

The embodiment described above is intended to illustrate the present invention and should not be construed as restricting the invention defined in the appended claims or reducing the scope thereof. Further devices of the invention are not limited to those of the foregoing embodiments in construction but can of course be modified variously without departing from the spirit of the invention as set forth in the claims.

For example, the functions assigned to the special function button 6 can be shown on the display 4. Alternatively, with LED arranged on the DVD player, the LED can be turned on only when the function is assigned to the special function button 6.

Furthermore, a plurality of special function buttons can be arranged on the player.

What is claimed is:

1. A signal reproducing apparatus for placing a recording medium therein and reproducing a signal and management information of the signal which are recorded on the medium, the signal reproducing apparatus comprising:
one or more manipulation buttons,
storing means for storing a plurality of pieces of function information indicating a function to be performed when the one or more manipulation buttons are manipulated,
function specifying means for, with the recording medium placed therein, specifying function information in conformity with function-specifying information included in management information recorded on the recording medium from among a plurality of pieces of the function information stored in the storing means with respect to each manipulation button, and
means for activating an operation in conformity with the specified function information with respect to one of the one or more manipulation buttons when said manipulation button is manipulated with the recording medium placed therein.

2. A signal reproducing apparatus according to claim 1 wherein the function-specifying information comprises a plurality of parameters, and the function specifying means specifies function information based on the plurality of parameters.

3. A signal reproducing apparatus according to claim 1 wherein the management information includes an operational parameter and program for activating a predetermined operation based on a value of the operational parameter, the signal reproducing apparatus comprising:
parameter storing means for storing the operational parameter,
storage processing means for storing, in the storing means, the operational parameter included in the management information recorded on the recording medium with the recording medium placed therein,
the means for activating operation activates an operation for rewriting the operational parameter stored in the storing means when one manipulation button is manipulated, and the program activates a predetermined operation in accordance with a value of the operational parameter stored in the storing means.

4. A signal reproducing apparatus according to claim 1 wherein the reproducing apparatus comprises an information display and display controlling means for showing on the information display a function indicated by function information when the function information is specified by the function specifying means.
